(19) United States
(12) Patent Application Publication
(10) Pub. No.: US 2007/0018573 A1
(43) Pub. Date: Jan. 25, 2007

(54) Phosphor, production method thereof and light-emitting device using the phosphor

(75) Inventor: Kousuke Shioi, Chiba (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K,K.

(21) Appl. No.: 10/588,206

(22) PCT Filed: Feb. 17, 2005
(86) PCT No.: PCT/JP05/02957

§ 371 Date: Aug. 2, 2006

Related U.S. Application Data
(60) Provisional application No. 60/548,166, filed on Mar. 1, 2004.
(60) Provisional application No. 60/555,416, filed on Mar. 23, 2004.

(30) Foreign Application Priority Data
Feb. 18, 2004 (JP) 2004-040842
Mar. 17, 2004 (JP) 2004-075687

(51) Int. Cl. H01J 1/62

(52) U.S. Cl. 313/512; 313/503

(57) ABSTRACT

A phosphor characterized by being represented by the formula Eu_{2-X}Ln_{X}M_{Y}O_{3(y+1)}, wherein 0 ≦x <2, Y is 2 or 3, Ln represents at least one member selected from among Y, La, and Gd, and M represents at least one member selected from the group consisting of W and Mo. This phosphor is effectively excited by visible light or UV radiation having a wavelength of 220 to 550 nm for a desired light emission, particularly red light emission with a high efficiency. Therefore, the phosphor is advantageously employed in light-emitting devices such as a light-emitting screen, a light-emitting diode, and a fluorescent lamp.

### CROSS REFERENCE TO RELATED APPLICATION

This application is an application filed under 35 U.S.C. §111 (a) claiming benefit pursuant to 35 U.S.C. §119 (e) (1) of the filing date of the Provisional Application No. 60/548,166 filed on Feb. 24, 2004, and the filing date of the Provisional Application No. 60/555,416 filed on Mar. 23, 2004, pursuant to 35 U.S.C. §111 (b). The disclosures of these documents are incorporated herein by reference.

### TECHNICAL FIELD

The present invention relates to a phosphor which can be effectively excited by ultraviolet (hereinafter also referred to as UV) radiation or visible light for a desired light emission, a production method thereof, and a light-emitting device employing the phosphor. The phosphor is particularly preferred for emission of red light.

### BACKGROUND ART

A variety of light-emitting diodes (hereinafter also referred to as LEDs) which emit light of a different wavelength have been developed through combination of a light-emitting element fabricated from a semiconductor (e.g., nitride compound semiconductor) that effectively emits UV radiation or visible light and a phosphor which can be effectively excited by UV radiation or visible light for a desired light emission. At present, a blue-emitting phosphor of (Sr, Ca, Ba)₁₀(PO₄)₆Cl₂:Eu, a green-emitting phosphor of 3 (Ba, Mg, Mn)O.8Al₂O₃:Eu, and a red-emitting phosphor of Y₂O₂S:Eu are disclosed as phosphors which are studied for application to the above use (see Japanese Patent Application Laid-Open (kokai) No. 2002-203991). Various emission colors can be attained through mixing of these phosphors of three emission types at arbitrary proportions. In order to attain white emission, a phosphor Y₂O₂S:Eu serving as a red-emitting component must be used in a large amount, because, as compared with the other two phosphor components, the red-emitting phosphor exhibits considerably lower emission efficacy, which is problematic. White emission is attainable when a good balance is established between among red, green, and blue emission. In this connection, emission from a green-emitting phosphor and that from a blue-emitting phosphor must be suppressed so as to attain the balance, since the red emission component exhibits poor emission efficacy. Therefore, hitherto, high-luminance white light has not yet been attained from these phosphors.

Meanwhile, a phosphor which can be excited by UV-A radiation or near UV radiation (300 to 410 nm) for a desired light emission is a candidate phosphor to be incorporated into a light-emitting screen, a decorative panel formed by incorporating the phosphor into concrete, glass, or similar material, an indirect luminaire, etc. However, in order to fully attain the desired effect, improvement in emission luminance of the phosphor is required.

An object of the present invention is to solve the aforementioned problems and to provide a phosphor which is effectively excited by UV radiation or visible light suitable for red light emission. Another object of the invention is to provide a light-emitting device employing the phosphor.

### SUMMARY OF THE INVENTION

The present inventors have conducted extensive studies in order to attain the aforementioned objects, and have found that a phosphor represented by the formula Eu₂₋ₓLnₓM₂O₉ (0 ≦x <2, wherein Ln represents at least one member selected from among Y, La, and Gd, and M represents at least one member selected from W and Mo) emits high-intensity red light when excited by UV radiation or visible light having a wavelength of 220 to 550 nm, and also found that a light-emitting device such as a light-emitting diode employing the red-emitting phosphor exhibits excellent emission characteristics. The present invention has been accomplished on the basis of these findings.

Accordingly, the present invention is directed to the following.

(1) A phosphor characterized by being represented by the formula Eu_{2-X}LnₓM_{y}O_{3(y+1)}, wherein 0≦x<2, Y is 2 or 3, Ln represents at least one member selected from among Y, La, and Gd, and M represents at least one member selected from the group consisting of W and Mo.

(2) A phosphor characterized by being represented by the formula Eu₂₋ₓLnₓM₂O₉, wherein 0≦x<2, Ln represents at least one member selected from among Y, La, and Gd, and M represents at least one member selected from the group consisting of W and Mo.

(3) A phosphor characterized by being represented by the formula Eu₂₋ₓLnₓM₃O₁₂, wherein 0<x<2, wherein Ln represents at least one member selected from among Y, La, and Gd, and M represents at least one member selected from W and Mo.

(4) A phosphor as described in (2) above, wherein x in the formula Eu₂₋ₓLnₓM₂O₉ satisfies the condition 0≦x<1.5.

(5) A phosphor as described in (3) above, wherein x in the formula Eu₂₋ₓLnₓM₃O₁₂ satisfies the condition 0≦x<1.8.

(6) A phosphor as described in any one of (1) to (5) above, wherein M is W.

(7) A phosphor as described in any one of (1) to (6) above, wherein Ln is Y.

(8) A phosphor as described in any one of (1) to (7) above, which has a particle size of 50 μm or less.

(9) A phosphor as described in any of (1) to (8) above, which emits red light.

(10) A light-emitting device comprising a light-emitting element and a phosphor as recited in any of (1) to (9) above in combination.

(11) A light-emitting device as described in (10) above, wherein the light-emitting element is a nitride semiconductor light-emitting element and emits light having a wavelength falling within a range of 220 nm to 550 nm.

(12) A light-emitting screen employing a phosphor as recited in any of (1) to (9) above.

(13) A method for producing a phosphor as recited in any one of (1) to (9) above, characterized in that the method comprises firing, at 800 to 1,300° C., a mixture containing europium oxide or a compound forming europium oxide through heating; yttrium oxide, lanthanum oxide, gadolinium oxide, or at least one compound forming any of these oxides through heating; and tungsten oxide, molybdenum oxide, or at least one compound forming any of these oxides through heating.

The phosphor of the present invention is effectively excited by visible light or UV radiation having a wavelength of 220 to 550 nm for desired light emission. Therefore, the phosphor is advantageously employed in light-emitting devices such as a light-emitting screen, a light-emitting diode, and a fluorescent lamp. LEDs emitting light of various colors can be fabricated from the phosphor of the present invention or a plurality of phosphors including the phosphor of the present invention. In the case of a white LED, color rendering properties and luminance can be enhanced.

### BRIEF DESCRIPTION OF THE DRAWINGS

FIG. 1 is a chart showing an excitation spectrum of the phosphor produced in Example 1.

FIG. 2 is a chart showing an excitation spectrum of the phosphor produced in Example 21.

FIG. 3 is a schematic sectional view of a light emitting device of an example of the present invention.

FIG. 4 is a schematic sectional view of a light emitting device of another example of the present invention.

FIG. 5 is a schematic sectional view of a white LED.

FIG. 6 is a schematic view of a light emitting screen comprising a phosphor.

### BEST MODES FIR CARRYING OUT THE INVENTION

The phosphor of the present invention is represented by the formula Eu_{2-X}Ln_{X}M_{Y}O_{3(y+1)}, wherein 0≦x<2, y is 2 or 3, wherein Ln represents at least one member selected from among Y, La, and Gd, and M represents at least one member selected from W and Mo.

In the phosphor represented by Eu₂₋ₓLnₓM₂O₉, when x satisfies the condition 0≦x≦1.5, emission intensity can be further enhanced and, particularly, when x satisfies the condition 0≦x≦1.0, remarkably high emission intensity can be attained. In the phosphor represented by Eu₂₋ₓLnₓM₃O₁₂, when x satisfies the condition 0≦x≦1.8, emission intensity can be further enhanced, and particularly when x satisfies the condition 0≦x≦1.5, remarkably high emission intensity can be attained. For M in the formula Eu₂₋ₓLnₓM_{y}O_{3(y+1)}, W is preferred.

Generally, the emission intensity of a phosphor depends on activator concentration. The phosphor of the present invention contains a europium ion serving as an activator. Thus, when europium concentration is the maximum, the highest-intensity emission can be attained.

However, concentration quenching is known to occur at a high activator concentration for, for example, the following reasons: (i) cross-relaxation between activators occurs via resonance transfer, thereby consuming a portion of excitation energy; (ii) resonance transfer between activators causes a detour of an excitation pathway, thereby promoting quenching or transfer of excitation to crystal surfaces or non-radiative centers; and (iii) aggregation of activators or formation of activator pairs converts activators to non-radiative centers or killers (fluorescence suppressors).

In view of the foregoing, the present invention pursues the possible broadest compositional range so as to attain high-intensity light emission.

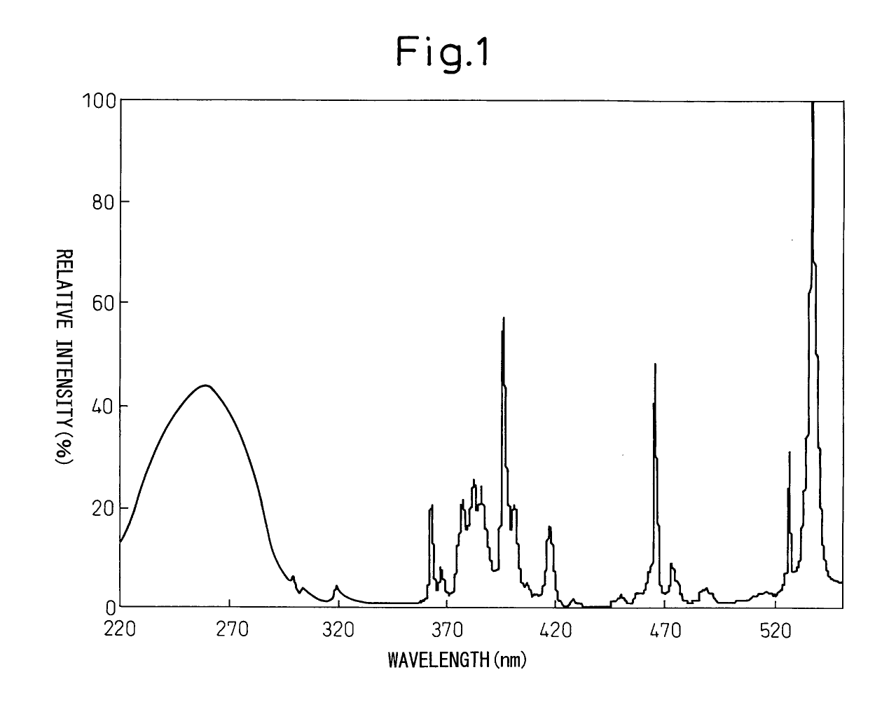

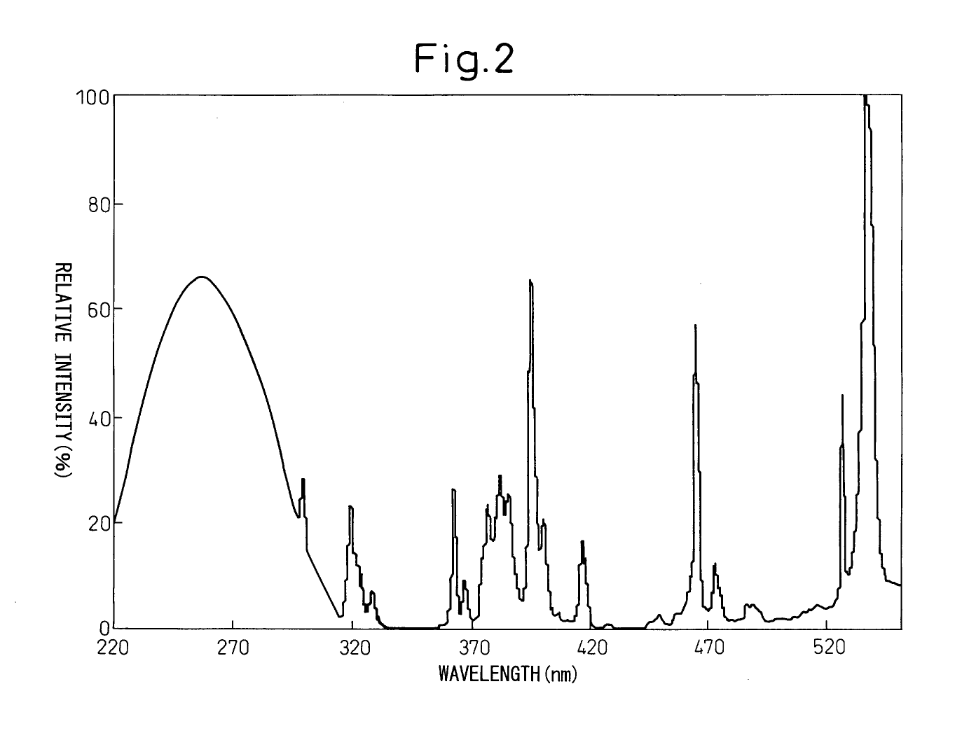

FIGS. 1 and 2 show excitation (with respect to emission at 614 nm) spectrums of the phosphor produced in Examples 1 and 21, respectively. As shown these figures, the phosphor exhibits excitation peaks within a wavelength range of 220 nm to 550 nm, indicating that the phosphor of the present invention is effectively excited by visible light or UV radiation having a wavelength falling within the above range and emits red light. In addition, as the phosphor is also effectively excited by UV radiation of 254 nm, the phosphor can be effectively employed in a fluorescent lamp for general use.

The phosphor of the present invention can be excited by UV-A radiation or near UV radiation (wavelength range: 300 to 410 nm) for a desired light emission. Therefore, the phosphor can be incorporated into a light-emitting screen, a decorative panel formed by incorporating the phosphor into concrete, glass, or similar material, an indirect luminaire, etc. The decorative panel is a product which exerts decorative effect or indirect light effect attributed to a display effect under sunlight or light from an ordinary fluorescent lamp and a display effect under UV-A radiation or near UV radiation emitted from a UV lamp.

An optimum concentration of a phosphor to be dispersed in a resin or the like is influenced by the kind of the matrix used such as the resin, the molding temperature, the viscosity of the raw material, the particle shape, particle size and particle size distribution of the phosphor, and others. Thus, the concentration of the phosphor may be selected in accordance with conditions of use or other factors. In order to control distribution of the phosphor with high dispersibility, the phosphor preferably has a mean particle size of 50 μm or less, more preferably 0.1 to 10μm.

The phosphor of the present invention may be produced through the following procedure. When a europium compound, an yttrium compound, and a tungsten compound, each forming an oxide by heating, are employed as a phosphor source, these compounds are weighed so as to attain the proportions which meet the formula EU₂₋ₓYₓW₂O₉ (0 ≦x <2). The compounds are mixed together. If required, an optional flux may be added to the phosphor raw material. The thus-produced raw material mixture is placed in an alumina crucible or the like and fired in the air at 800 to 1,300° C. for several hours. After cooling, the fired product is crushed and pulverized by means of a ball mill or a similar device, and the obtained powder is washed with water, if required. The solid is separated from the liquid, dried, crushed, and classified, to thereby obtain the phosphor of the present invention.

Oxides or compounds which form the corresponding oxides by heating are preferably employed as the phosphor raw materials. Examples of preferred compounds include europium compounds such as europium carbonate, europium oxide, and europium hydroxide; yttrium compounds such as yttrium carbonate, yttrium oxide, and yttrium hydroxide; lanthanum compounds such as lanthanum carbonate, lanthanum oxide, and lanthanum hydroxide; gadolinium compounds such as gadolinium carbonate, gadolinium oxide, and gadolinium hydroxide; tungsten compounds such as tungsten oxide and tungstic acid; and molybdenum compounds such as molybdenum oxide and molybdic acid. Other than the above-described compounds, an organometallic compounds containing europium, yttrium, lanthanum, gadolinium, tungsten, or molybdenum, and other similar compounds may be employed in a vapor phase or liquid phase process, to thereby produce the phosphor of the present invention or a raw material mixture. The flux is preferably an alkali metal halide, an alkaline earth metal halide, ammonium fluoride, etc. The flux is added in an amount of 0.01 to 1.0 part by weight based on 100 parts by weight of the entirety of the phosphor raw material.

Since the phosphor of the present invention is effectively excited by visible light or UV radiation having a wavelength of 220 nm to 550 nm for a desired light emission, the phosphor is advantageously used in a fluorescent lamp. Through a combination of the phosphor of the present invention with a light-emitting diode which exhibits an emission peak within a wavelength range of 220 nm to 550 nm, LEDs of various colors may be produced. For example, through a combination of the phosphor of the present invention with a light-emitting diode which emits UV-A radiation or near UV radiation having a wavelength range of 220 to 410 nm, a red-light-emitting LED can be produced.

Alternatively, through a combination of the phosphor of the present invention with a light-emitting diode which emits visible light having a wavelength range of 400 to 550 nm, the light emitted from the red-emitting phosphor excited by visible light and the visible light emitted from the light-emitting diode are mixed, whereby LEDs that emit light of various colors can be produced. Further alternatively, through a combination of a plurality of phosphors including the phosphor of the present invention and the aforementioned light-emitting diode, LEDs that emit light of various colors can be produced. Particularly when the phosphor of the present invention is employed in a white LED, the color rendering properties and the luminance can be enhanced.

The light-emitting device of the present invention is a light-emitting device such as an LED or a fluorescent lamp. The device of the present invention will be described by taking an LED light-emitting device as an example. The device is fabricated from the phosphor of the present invention and, in combination, a semiconductor light-emitting element which emits light having a wavelength of 220 nm to 550 nm. The semiconductor light-emitting element is produced from any of a variety of semiconductors such as ZnSe and GaN. The light-emitting element employed in the present invention exhibits an emission peak within a wavelength of 220 nm to 550 nm. Thus, a gallium nitride compound semiconductor, which effectively excites the aforementioned phosphor, is preferably employed. The light-emitting element may be produced by forming a nitride compound semiconductor on a substrate through MOCVD, HVPE, or a similar technique. Preferably, In_{α}Al_{β}Ga_{1-α-β}N (0≦α, 0≦β, α+β≦1) is formed to serve as a light-emitting layer. The semiconductor structure may be a homo-, hetero-, or doublehetero-structure including an MIS junction, a PIN junction, or a pn junction. A variety of emission wavelengths may be attained through selection of a material for forming the semiconductor layer and the compositional proportions of the mixed crystals. Alternatively, a single quantum well structure or a multiple quantum well structure, in which a semiconductor active layer is formed from a thin film exhibiting a quantum effect, may also be employed.

The aforementioned phosphor layer to be provided on the light-emitting element may be formed of a single layer containing at least one phosphor, or a plurality of the layers may be stacked. A single layer may contain a plurality of phosphors. Examples of the mode of provision of the phosphor layer on the light-emitting element include incorporating a phosphor into a coating material for covering the surface of the light-emitting element; incorporating a phosphor into a molding member; incorporating a phosphor into a cover member for covering the molding member; and incorporating a phosphor into a light-permeable plate disposed on the light emission side of an LED lamp.

Alternatively, at least one species of the aforementioned phosphors may be incorporated into the molding member provided on the light-emitting element. In addition, a phosphor layer containing at least one species of the aforementioned phosphors may be provided on the outside of the light-emitting diode. Examples of the mode of provision of the phosphor layer on the outside of the light-emitting diode include forming a phosphor coating layer on the outer surface of the molding member of the light-emitting diode; and forming a molded product (e.g., a cap) in which a phosphor is dispersed in rubber, resin, elastomer, low-melting-point glass, etc., followed by covering the LED with the molded product or placing a plate produced from the molded product on the light emission side of the LED.

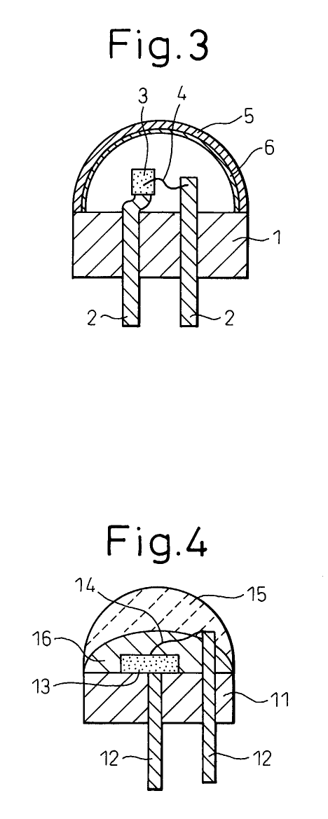

FIGS. 3 and 4 show light emitting devices of examples of the present invention, which comprises a phosphor and a light emitting diode. In FIG. 3, a semiconductor light emitting chip (LED) 3 is mounted on a stem with a mounting lead 2 and is connected to another lead 2 via a gold wire, and the semiconductor light emitting chip (LED) 3 is surrounded by a transparent resin or low melting point glass cover 5 inside of which a phosphor layer 6 is provided. In FIG. 4, a semiconductor light emitting chip (LED) 13 is mounted on a header 11 with a mounting lead 12 and covered with a coated phosphor layer 16 which is further covered with a resin or low melting point glass lens 15. The semiconductor light emitting chip (LED) 13 is connected to another lead 12 via a gold wire 14.

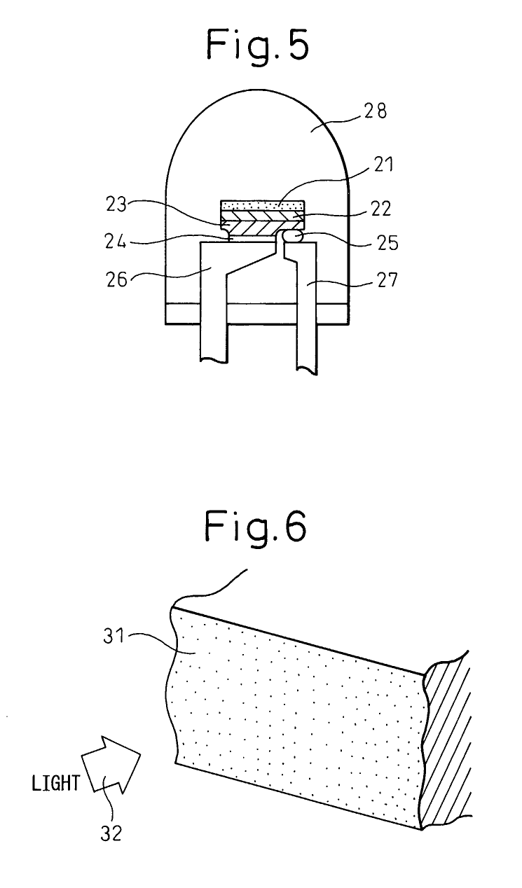

FIG. 5 shows an example of a white LED, in which a semiconductor LED, comprising a stack of an electrode 24 and a III-group nitride semiconductor layer 23, in this order, on a sapphire substrate 22, is mounted on a mounting lead 26 and connected to an inner lead 27 via another electrode 25, and a phosphor layer 21 is arranged on the top of the semiconductor LED which, as a whole, is molded in a resin 28. Thus, light emitted from the semiconductor LED, for example, a blue light, excites the phosphor in the phosphor layer 21 which in turn emits a modified color light, for example, green and red lights, by which the light emitted from the semiconductor LED and the light modified by the phosphor layer 21 are blended to compose white light.

FIG. 6 shows an example of a light emitting screen which is a wall 31 made of concrete, glass or other material and containing a phosphor, by which the wall emits a predetermined light and providing a decoration effect by the phosphor contained in the wall being excited by illumination light or natural light 32.

### EXAMPLES

Examples of the present invention will next be described. However, needless to say, the Examples should not be construed as limiting the invention thereto. In the following Examples, emission spectra were measured by use of an FP-6500 (product of JASCO corporation).

### Example 1

WO₃ powder (59.62 g), Eu₂O₃ powder (31.67 g), and Y₂O₃ powder (8.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}W₂O₉ and having a mean particle size of 5.8 μm. When the phosphor was excited at 395 nm for emission, red emission was observed. The emission intensity (relative intensity) of this sample in the emission spectrum was found to be 100 (the same applies to the following). The excitation spectrum of the phosphor is shown in FIG. 1.

### Example 2

WO₃ powder (56.85 g) and Eu₂O₃ powder (43.15 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu₂W₂O₉ and having a mean particle size of 6.0 μm. When the phosphor was excited at 395 nm for emission, red emission was observed. The emission intensity of this sample in the emission spectrum was found to be 91.3.

### Example 3

WO₃ powder (57.75 g), Eu₂O₃ powder (39.44 g), and Y₂O₃ powder (2.81 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.8}Y_{0.2}W₂O₉ and having a mean particle size of 5.9 μm. When the phosphor was excited at 395 nm for emission, red emission was observed. The emission intensity of this sample in the emission spectrum was found to be 94.7.

### Example 4

WO₃ powder (61.62 g), Eu₂O₃ powder (23.38 g), and Y₂O₃ powder (15 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of EuYW₂O₉ and having a mean particle size of 5.0 μm. When the phosphor was excited at 395 nm for emission, red emission was observed. The emission intensity of this sample in the emission spectrum was found to be 93.8.

### Example 5

WO₃ powder (63.75 g), Eu₂O₃ powder (14.51 g), and Y₂O₃ powder (21.73 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{0.6}Y_{1.4}W₂O₉ and having a mean particle size of 5.1 μm. When the phosphor was excited at 395 nm for emission, red emission was observed. The emission intensity of this sample in the emission spectrum was found to be 68.3.

### Example 6

WO₃ powder (66.04 g), Eu₂O₃ powder (5.01 g), and Y₂O₃ powder (28.95 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{0.2}Y_{1.8}W₂O₉ and having a mean particle size of 7.0 μm. When the phosphor was excited at 395 nm for emission, red emission was observed. The emission intensity of this sample in the emission spectrum was found to be 38.6.

### Example 7

WO₃ powder (59.62 g), Eu₂O₃ powder (31.67 g), and Y₂O₃ powder (8.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}W₂O₉ and having a mean particle size of 2.3 μm. When the phosphor was excited at 395 nm for emission, red emission was observed. The emission intensity of this sample in the emission spectrum was found to be 98.8.

### Example 8

WO₃ powder (59.62 g), Eu₂O₃ powder (31.67 g), and Y₂O₃ powder (8.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for 12 hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}W₂O₉ and having a mean particle size of 27.6 μm. When the phosphor was excited at 395 nm for emission, red emission was observed. The emission intensity of this sample in the emission spectrum was found to be 92.6.

### Example 9

WO₃ powder (59.62 g), Eu₂O₃ powder (31.67 g), and Y₂O₃ powder (8.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for 12 hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}W₂O₉ and having a mean particle size of 47.8 μm. When the phosphor was excited at 395 nm for emission, red emission was observed. The emission intensity of this sample in the emission spectrum was found to be 88.4.

### Example 10

When the phosphor produced in Example 9 was excited at 465 nm for emission, red emission was observed. The emission intensity of this sample in the emission spectrum was found to be 88.4.

### Example 11

WO₃ powder (59.62 g), Eu₂O₃ powder (31.67 g), and Y₂O₃ powder (8.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}W₂O₉ and having a mean particle size of 5.8 μm. When the phosphor was excited at 256 nm for emission, red emission was observed. The emission intensity of this sample in the emission spectrum was found to be 94.6.

### Example 12

WO₃ powder (57.4 g), Eu₂O₃ powder (30.5 g), and La₂O₃ powder (12.1 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}La_{0.6}W₂O₉ and having a mean particle size of 5.2 μm. When the phosphor was excited at 395 nm for emission, red emission was observed. The emission intensity of this sample in the emission spectrum was found to be 97.2.

### Example 13

WO₃ powder (56.63 g), Eu₂O₃ powder (30.09 g), and Gd₂O₃ powder (13.28 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Gd_{0.6}W₂O₉ and having a mean particle size of 5.5 μm. When the phosphor was excited at 395 nm for emission, red emission was observed. The emission intensity of this sample in the emission spectrum was found to be 99.1.

### Example 14

MoO₃ powder (47.82 g), Eu₂O₃ powder (40.92 g), and Y₂O₃ powder (11.25 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Eu_{1.4}Y_{0.6}Mo₂O₉ and having a mean particle size of 5.9 μm. When the phosphor was excited at 395 nm for emission, red emission was observed. The emission intensity of this sample in the emission spectrum was found to be 87.6.

### Comparative Example 1

WO₃ powder (67.25 g) and Y₂O₃ powder (32.75 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,200° C. for six hours in the air. The thus-fired product was sufficiently washed with pure water, so as to remove unnecessary components that are soluble in water. Subsequently, the washed fired product was pulverized by use of a ball mill and classified, to thereby produce a phosphor represented by a formula of Y₂W₂O₉ and having a mean particle size of 6.0 μm. When the phosphor was excited at 395 nm for emission, the emission intensity of this sample in the emission spectrum was found to be 0.

### Comparative Example 2

When a conventional phosphor (Y₂O₂S:Eu) phosphor was excited at 395 nm for emission, red emission was observed. The emission intensity of this sample in the emission spectrum was found to be 23.1.

### Example 15

The phosphor produced in Example 1 was blended with silicone rubber, and the mixture was molded by means of a heat press apparatus, thereby forming a cap-shape product. The cap-shape product was attached to the outside of a near-UV LED (emission wavelength: 395 nm) such that the cap covers the LED. When the LED was operated, red emission was observed. After the LED had been lighted for 500 hours at 60° C. under 90% RH conditions, no change attributed to the phosphor was observed in the red emission.

### Example 16

The phosphor produced in Example 1, Sr₅(PO₄)₃Cl:Eu serving as a blue-emitting phosphor, and BaMg₂Al₁₆O₂₇:Eu, Mn serving as a green phosphor were blended with silicone rubber, and the mixture was mounted on a near-UV light-emitting device (emission wavelength: 395 nm), thereby fabricating a white LED. The emitted white light exhibited a general color rendering index of 87.

### Example 17

The phosphor produced in Example 1 and Y₃Al₅O₁₂:Ce serving as a yellow-emitting phosphor were blended with epoxy resin, and the mixture was mounted on a blue-light-emitting device (emission wavelength: 465 nm), thereby fabricating a white LED. The emitted white light exhibited a general color rendering index of 78.

### Example 18

The phosphor produced in Example 1, Sr₅(PO₄)₃Cl:Eu serving as a blue-emitting phosphor, and BaMg₂Al₁₆O₂₇: (Eu,Mn) serving as a green-emitting phosphor were blended with silicone rubber, and the mixture was mounted on a near-UV light-emitting device (emission wavelength: 395 nm), thereby fabricating a white LED. Y₂O₂S:Eu serving as a red-emitting phosphor, Sr₅(PO₄)₃Cl:Eu serving as a blue-emitting phosphor, and BaMg₂Al₁₆O₂₇:(Eu,Mn) serving as a green emission were blended with silicone rubber, and the mixture was mounted on a near-UV light-emitting device (emission wavelength: 395 nm), thereby fabricating another white LED. The LED containing the phosphor of the invention emitted white light exhibiting luminance 2.1 times that obtained from the LED employing Y₂O₂S:Eu serving as a red-emitting phosphor.

### Example 21

WO₃ powder (68.89 g), Eu₂O₃ powder (24.40 g), and Y₂O₃ powder (6.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}Y_{0.6}W₃O₁₂ and having a mean particle size of 4.5 μm. When the phosphor was excited at 395 nm for emission, red emission was observed. The emission intensity (relative intensity) of this sample in the emission spectrum was taken as 100 (the same applies to the following). The excitation spectrum of the phosphor is shown in FIG. 1.

### Example 22

WO₃ powder (66.40 g) and Eu₂O₃ powder (33.60 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu₂W₃O₁₂ and having a mean particle size of 5.8 μm. When the phosphor was excited at 395 nm for emission, red emission was observed. The emission intensity of this sample in the emission spectrum was found to be 71.

### Example 23

WO₃ powder (67.21 g), Eu₂0₃ powder (30.61 g), and Y₂O₃ powder (2.18 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.8}Y_{0.2}W₃O₁₂ and having a mean particle size of 4.7 μm. When the phosphor was excited at 395 nm for emission, red emission was observed. The emission intensity of this sample in the emission spectrum was found to be 91.

### Example 24

WO₃ powder (70.66 g), Eu₂O₃ powder (17.87 g), and Y₂O₃ powder (11.47 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of EuYW₃O₁₂ and having a mean particle size of 5.1 μm. When the phosphor was excited at 395 nm for emission, red emission was observed. The emission intensity of this sample in the emission spectrum was found to be 96.

### Example 25

WO₃ powder (72.51 g), Eu₂O₃ powder (11.01 g), and Y₂O₃ powder (16.48 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.6}Y_{1.4}W₃O₁₂ and having a mean particle size of 5.3 μm. When the phosphor was excited at 395 nm for emission, red emission was observed. The emission intensity of this sample in the emission spectrum was found to be 83.

### Example 26

WO₃ powder (74.47 g), Eu₂O₃ powder (3.77 g), and Y₂O₃ powder (21.76 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.2}Y_{1.8}W₃O₁₂ and having a mean particle size of 5.8 μm. When the phosphor was excited at 395 nm for emission, red emission was observed. The emission intensity of this sample in the emission spectrum was found to be 48.

### Example 27

WO₃ powder (66.34 g), Eu₂O₃ powder (30.21 g), and Gd₂O₃ powder (3.46 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.8}Gd_{0.2}W₃O₁₂ and having a mean particle size of 5.1 μm. When the phosphor was excited at 395 nm for emission, red emission was observed. The emission intensity of this sample in the emission spectrum was found to be 89.

### Example 28

WO₃ powder (66.20 g), Eu₂O₃ powder (23.45 g), and Gd₂O₃ powder (10.35 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}Gd_{0.6}W₃O₁₂ and having a mean particle size of 5.8 μm. When the phosphor was excited at 395 nm for emission, red emission was observed. The emission intensity of this sample in the emission spectrum was found to be 99.

### Example 29

WO₃ powder (66.07 g), Eu₂O₃ powder (16.71 g), and Gd₂O₃ powder (17.21 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of EuGdW₃O₁₂ and having a mean particle size of 5.5 μm. When the phosphor was excited at 395 nm for emission, red emission was observed. The emission intensity of this sample in the emission spectrum was found to be 96.

### Example 30

WO₃ powder (65.94 g), Eu₂O₃ powder (10.01 g), and Gd₂O₃ powder (24.06 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.6}Gd_{1.4}W₃O₁₂ and having a mean particle size of 5.5 μm. When the phosphor was excited at 395 nm for emission, red emission was observed. The emission intensity of this sample in the emission spectrum was found to be 83.

### Example 31

WO₃ powder (65.80 g), Eu₂O₃ powder (3.33 g), and Gd₂O₃ powder (30.87 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.2}Gd_{1.8}W₃O₁₂ and having a mean particle size of 5.8 μm. When the phosphor was excited at 395 nm for emission, red emission was observed. The emission intensity of this sample in the emission spectrum was found to be 53.

### Example 32

WO₃ powder (67.58 g), Eu₂O₃ powder (10.26 g), and La₂O₃ powder (22.16 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.6}La_{1.4}W₃O₁₂ and having a mean particle size of 5.8 μm. When the phosphor was excited at 395 nm for emission, red emission was observed. The emission intensity of this sample in the emission spectrum was found to be 79.

### Example 33

MoO₃ powder (57.89 g), Eu₂O₃ powder (33.03 g), and Y₂O₃ powder (9.08 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{l.4}Y_{0.6}Mo₃O₁₂ and having a mean particle size of 4.7 μm. When the phosphor was excited at 395 nm for emission, red emission was observed. The emission intensity of this sample in the emission spectrum was found to be 88.4.

### Example 34

WO₃ powder (68.89 g), Eu₂O₃ powder (24.40 g), and Y₂O₃ powder (6.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}Y_{0.6}W₃O₁₂ and having a mean particle size of 2.4 μm. When the phosphor was excited at 395 nm for emission, red emission was observed. The emission intensity of this sample in the emission spectrum was found to be 97.

### Example 35

WO₃ powder (68.89 g), Eu₂O₃ powder (24.40 g), and Y₂O₃ powder (6.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}Y_{0.6}W₃O₁₂ and having a mean particle size of 27.8 μm. When the phosphor was excited at 395 nm for emission, red emission was observed. The emission intensity of this sample in the emission spectrum was found to be 91.

### Example 36

WO₃ powder (68.89 g), Eu₂O₃ powder (24.40 g), and Y₂O₃ powder (6.71 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}Y_{0.6}W₃O₁₂ and having a mean particle size of 41.4 μm. When the phosphor was excited at 395 nm for emission, red emission was observed. The emission intensity of this sample in the emission spectrum was found to be 87.

### Example 37

WO₃ powder (66.57 g), Eu₂O₃ powder (30.31 g), and La₂O₃ powder (3.12 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.8}La_{0.2}W₃O₁₂ and having a mean particle size of 5.6 μm. When the phosphor was excited at 395 nm for emission, red emission was observed. The emission intensity of this sample in the emission spectrum was found to be 73.

### Example 38

WO₃ powder (66.90 g), Eu₂O₃ powder (23.70 g), and La₂O₃ powder (9.40 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{1.4}La_{0.6}W₃O₁₂ and having a mean particle size of 5.5 μm. When the phosphor was excited at 395 nm for emission, red emission was observed. The emission intensity of this sample in the emission spectrum was found to be 81.

### Example 39

WO₃ powder (67.24 g), Eu₂O₃ powder (17.01 g), and La₂O₃ powder (15.75 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of EuLaW₃O₁₂ and having a mean particle size of 5.9 μm. When the phosphor was excited at 395 nm for emission, red emission was observed. The emission intensity of this sample in the emission spectrum was found to be 87.

### Example 40

WO₃ powder (67.93 g), Eu₂O₃ powder (3.44 g), and La₂O₃ powder (28.64 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Eu_{0.2}La_{1.8}W₃O₁₂ and having a mean particle size of 5.8 μm. When the phosphor was excited at 395 nm for emission, red emission was observed. The emission intensity of this sample in the emission spectrum was found to be 45.

### Example 41

When the phosphor produced in Example 21 was excited at 465 nm for emission, red emission was observed. The emission intensity of this sample in the emission spectrum was found to be 86.1.

### Example 42

When the phosphor produced in Example 21 was excited at 256 nm for emission, red emission was observed. The emission intensity of this sample in the emission spectrum was found to be 98.

### Comparative Example 11

WO₃ powder (75.49 g) and Y₂O₃ powder (24.51 g) serving as raw materials for producing a phosphor were weighed accurately, and these powders were uniformly mixed by use of a ball mill, thereby producing a raw material mixture. The thus-produced raw material mixture was placed in an alumina crucible and fired at 1,000° C. for six hours in the atmosphere. The thus-fired product was pulverized by use of a ball mill and classified, to thereby produce a phosphor represented by a formula of Y₂W₃O₁₂ and having a mean particle size of 6.2 μm. When the phosphor was excited at 395 nm for emission, the emission intensity of this sample in the emission spectrum was found to be 0.

### Comparative Example 12

When a conventional phosphor (Y₂O₂S:Eu) was excited at 395 nm for emission, red emission was observed. The emission intensity of this sample in the emission spectrum was found to be 18.2.

### Example 43

The phosphor produced in Example 21 was blended in an amount of 20 mass % with silicone rubber, and the mixture was molded by means of a heat press apparatus, thereby forming a cap-shape product. The cap-shape product was attached to the outside of a near-UV LED (emission wavelength: 395 nm) such that the cap covers the LED. When the LED was operated, red emission was observed. After the LED had been lighted for 500 hours at 60° C. under 90% RH conditions, no change attributed to the phosphor was observed in the red emission.

### Example 44

The phosphor produced in Example 21, Sr₅(PO₄)₃Cl:Eu serving as a blue-emitting phosphor, and BaMg₂Al₁₆O₂₇: (Eu, Mn) serving as a green-emitting phosphor were blended with silicone rubber in amounts of 22.7 mass %, 3.8 mass %, and 3.4 mass %, respectively, and the mixture was mounted on a near-UV light-emitting device (emission wavelength: 395 nm), thereby fabricating a white LED. The emitted white light exhibited a general color rendering index of 89.

### Example 45

The phosphor produced in Example 21 and Y₃Al₅O₁₂:Ce serving as a yellow-emitting phosphor were blended with epoxy resin in amounts of 8.8 mass% and 17.6 mass %, respectively, and the mixture was mounted on a blue-light-emitting device (emission wavelength: 465 nm), thereby fabricating a white LED. The emitted white light exhibited a general color rendering index of 81.

### Example 46

The phosphor produced in Example 21, Sr₅(PO₄)₃Cl:Eu serving as a blue-emitting phosphor, and BaMg₂Al₁₆O₂₇: (Eu, Mn) serving as a green-emitting phosphor were blended with silicone rubber in amounts of 22.7 mass %, 3.8 mass %, and 3.4 mass %, respectively, and the mixture was mounted on a near-UV light-emitting device (emission wavelength: 395 nm), thereby fabricating a white LED. Y₂O₂S:Eu serving as a red-emitting phosphor, Sr₅(PO₄)₃Cl:Eu serving as a blue-emitting phosphor, and BaMg₂Al₁₆O₂₇: (Eu,Mn) serving as a green-emitting phosphor were blended with silicone rubber in amounts of 45.8 mass %, 3.8 mass %, and 3.4 mass %, respectively, and the mixture was mounted on a near-UV light-emitting device (emission wavelength: 395 nm), thereby fabricating another white LED. The LED containing the phosphor of the invention emitted white light exhibiting luminance 2.7 times that obtained from the LED employing Y₂O₂S:Eu serving as a red-emitting phosphor.

### INDUSTRIAL APPLICABILITY

The phosphor of the present invention can be employed in a light-emitting screen, a decorative panel formed by incorporating the phosphor into concrete, glass, or similar material, an indirect luminaire, etc. The phosphor of the invention can be effectively used in light-emitting devices such as a light-emitting diode and a fluorescent lamp.

1. A phosphor characterized by being represented by the formula Eu₂₋ₓLnₓM_{Y}O_{3(y+1)}, wherein 0≦x<2, Y is 2 or 3, Ln represents at least one member selected from among Y, La, and Gd, and M represents at least one member selected from the group consisting of W and Mo.

2. A phosphor characterized by being represented by the formula Eu₂₋ₓLnₓM₂O₉, wherein 0≦x<2, Ln represents at least one member selected from among Y, La, and Gd, and M represents at least one member selected from the group consisting of W and Mo.

3. A phosphor characterized by being represented by the formula Eu₂₋ₓLnₓM₃O₁₂, wherein 0≦x<2, wherein Ln represents at least one member selected from among Y, La, and Gd, and M represents at least one member selected from W and Mo.

4. A phosphor as described in claim 2, wherein x in the formula Eu₂₋ₓLnₓM₂O₉ satisfies the condition 0≦x≦1.5.

5. A phosphor as described in claim 3, wherein x in the formula Eu₂₋ₓLnₓM₃O₁₂ satisfies the condition 0≦x≦1.8.

6. A phosphor as described in claim 1, wherein M is W.

7. A phosphor as described in claim 1, wherein Ln is Y.

8. A phosphor as described in claim 1, which has a particle size of 50 μm or less.

9. A phosphor as described in claim 1, which emits red light.

10. A light-emitting device comprising a light-emitting element and a phosphor as recited in claim 1.

11. A light-emitting device as described in claim 10, wherein the light-emitting element is a nitride semiconductor light-emitting element and emits light having a wavelength falling within a range of 220 nm to 550 nm.

12. A light-emitting screen employing a phosphor as recited in claim 1.

13. A method for producing a phosphor as recited in claim 1, characterized in that the method comprises firing at 800 to 1,300° C. a mixture containing europium oxide or a compound forming europium oxide through heating; yttrium oxide, lanthanum oxide, gadolinium oxide, or at least one compound forming any of these oxides through heating; and tungsten oxide, molybdenum oxide, or at least one compound forming any of these oxides through heating.
